(19) United States
(12) Patent Application Publication
(10) Pub. No.: US 2015/0140314 A1
(43) Pub. Date: May 21, 2015

(54) Surface treatment method on Micro-arc Oxidation treated Mg alloys

(71) Applicant: Nano and Advanced Materials Institute Limited, Hong Kong (CN)

(72) Inventors: Hong TAO, Hong Kong (CN); King Ho SO, Hong Kong (CN); Siyue LI, Hong Kong (CN); Xuezhu ZHANG, Hong Kong (CN); Kwok Cheong LAI, Hong Kong (CN)

(73) Assignee: Nano and Advanced Materials Institute Ltd.

(21) Appl. No.: 14/543,911

(22) Filed: Nov. 18, 2014

Related U.S. Application Data
(60) Provisional application No. 61/963,017, filed on Nov. 21, 2013.

(51) Int. Cl. C23C 18/00; C22C 23/00; C23F 1/00; B05D 1/18; H01B 13/00

(52) U.S. Cl. CPC C23C 18/00; B05D 1/18; H01B 13/0026; C23F 1/00; C22C 23/00
USPC 428/312.8; 428/337; 428/323; 428/335; 427/372.2; 427/58; 427/379; 216/100

(57) ABSTRACT

Chemically and mechanically protective oxide film was formed on Mg alloys using micro-arc oxidation (MAO) methods. Further modification of the obtained MAO surfaces was made in various aspects and the processes thereof were described. Firstly, the protection is enhanced by forming super-hydrophobic surfaces, with water contact angle higher than 140°, attributed to hierarchical nano-micro structures. Secondly, the electrical property of the MAO surfaces is modified. A film with sheet resistance as low as 0.05 Ω/sq is achieved by electro-less Ni deposition on MAO surfaces. Thirdly, black colors are achieved by the sol-gel process on MAO samples.

### CROSS-REFERENCE TO RELATED APPLICATION

This application claims benefit under 35 U.S.C. §119(e) of U.S. Provisional Application having Ser. No. 61/963,017 filed 21 Nov. 2013, which is hereby incorporated by reference herein in its entirety.

### FIELD OF INVENTION

This invention relates to the methods of forming functional coatings on the surface of micro-arc oxidation (MAO) treated magnesium (Mg) alloys to modify the surface properties thereof.

### BACKGROUND OF INVENTION

Due to good properties such as light weight, high strength-to-weight ratio, good electromagnetic shielding property and castability, Mg alloys have been increasingly used as laptop housing and mobile phone housing materials. However, because of the active positions in both electromotive force series and galvanic series, Mg alloys corrode quickly in atmospheric environment, especially in humid environment [1]. Therefore, anti-corrosion surface treatment is an indispensable manufacturing process for Mg alloy products.

Among various anti-corrosion surface treatment methods, micro-arc oxidation (MAO) treatment is promising and efficient to form thick ceramic layers with good adhesion to the substrate, which is also environmental friendly with good cost efficiency. Depending on the electrolyte formulation, a combination of Mg based ceramic layer is formed on the surface thereof. However, the manufacturers are not satisfied with MAO process in several aspects. Firstly, the corrosion resistance needs to be further enhanced. Secondly, the MAO treated surface layer is insulating both thermally and electrically. When MAO process is applied to electronics housing materials, the insulating properties will affect several properties of Mg alloy including thermal dissipation, electrical conductivity, and electromagnetic interference shielding property, especially on the internal surfaces. Thirdly, users are not satisfied with the color of MAO treated surface. Only a very narrow range of color selection is available after MAO coating, i.e. grey at different scales.

Therefore, there is a need to provide satisfying surface treatment methods on the surface of MAO treated Mg alloy.

### SUMMARY OF INVENTION

In the light of the foregoing background, it is an object of the present invention to provide an alternate surface treatment methods on the surface of MAO treated Mg alloy

Accordingly, the present invention, in the first aspect, is a method of treating the surface of micro-arc oxidation treated magnesium (Mg) alloy, including the steps of:
a. providing a MAO treated Mg alloy sample;
b. immersing the sample into a solution; and
c. drying the sample of step (b);

wherein, the surface of the treated sample obtained from step (c) is super-hydrophobic.

In an exemplary embodiment of the present invention, the water contact angle of the surface of the treated sample after the step (c) is at least 140.4°. In another exemplary embodiment, the sample of step (a) is etched with NaOH solution before step (b). In a further exemplary embodiment, the solution is selected from a group consisting of perfluorodecyltrimethoxysilane, triethoxyoctylsilane and perfluorodecyltriethoxysilane.

In another exemplary embodiment, the solution is tetraethyl orthosilicate mixed with silanes, and the step (b) and step (c) are repeated twice.

In the second aspect, the present invention provides a magnesium alloy including a magnesium based ceramic layer of 5-40 μm thickness; and a super-hydrophobic coating thereon, the coating includes a silane layer such that the surface has a water contact angle of at least 140.4°.

In an exemplary embodiment, the product is manufactured by the process described above in the 2^{nd} to 7^{th} paragraph of the Summary of Invention. In a further exemplary embodiment, the surface of the alloy includes a flake-like structure, and the flake of the flake-like structure has a length of 100-200 nm.

In an exemplary embodiment, the product is manufactured by the process described above in the 2^{nd} to 6^{th} and 8^{th} paragraphs of the Summary of Invention. In a further exemplary embodiment, the surface includes nanoparticles with a size of 200 nm.

In the third aspect, the present invention provides a method of treating the surface of micro-arc oxidation treated magnesium alloy, including:
a. providing a micro-arc oxidation treated magnesium alloy sample;
b. pre-treating the sample with nickel acetate solution in ethanol solution;
c. activating the pre-treated sample with a solution of reducing agent; and
d. forming electro-less Ni on the surface of the activated sample with a deposition solution,

wherein, the treated sample obtained from step (d) is electrically conductive.

In an exemplary embodiment, the solution of reducing agent is an ethanol solution of NaBH₄. In another exemplary embodiment, the deposition solution includes NiSO₄.6H₂O, NaH₂PO₂.H₂O, Na-citrate, H₃H₆O₃, C₃H₆O₃ and thiourea. In another exemplary embodiment, the sheet resistance of the treated sample obtained from step (d) is less than 0.05 Ω/sq and measured by the four-point-probe method.

In the fourth aspect, the present invention provides a magnesium alloy including a layer of nickel of 10-30 μm thickness on the alloy with a micro-arc oxidation treated layer of 5-40 μm thickness therebetween. The layer of nickel forms a uniform surface on the micro-arc oxidation treated layer to provide improved conductivity such that the alloy has a sheet resistance of less than 0.05 Ω/sq.

In an exemplary embodiment, the micro-arc oxidation treated layer has pores with an average pore size of 1-3 μm that are filled by nickel. In another exemplary embodiment, the product is manufactured by the process described above in the third aspect.

In the fifth aspect, the present invention provides a method of treating the surface of micro-arc oxidation treated magnesium alloy, comprising:
a. providing a micro-arc oxidation treated magnesium alloy sample;
b. immersing the sample into a silane solution;
c. drying the sample of the step (b); and
d. annealing the sample of the step (c);

wherein the solution is tetraethyl orthosilicate mixed with silanes, and the step (b) and step (c) are repeated three more times,

wherein the color of the surface matches with the standard color code PANTONE 19-0303.

In the sixth aspect, the present invention provides a magnesium alloy comprising a magnesium based ceramic layer of 5-40 μm thickness, and a silane coating thereon, wherein surface color of the alloy matches with the standard color code PANTONE 19-0303. In an exemplary embodiment, the magnesium alloy is manufactured by the process of the fifth aspect.

### BRIEF DESCRIPTION OF FIGURES

FIGS. 1(a) and (b) show the nano-structures formed on MAO treated surface in chemical etching processes and the water contact angle thereof.

FIGS. 2(a) and (b) show the nano-particles with an uniform size of 200 nm formed on the MAO treated surface by sol-gel process and the water contact angle thereof.

FIGS. 3(a) and (b) show the SEM image of the surface of the Ni deposition on MAO treated samples and the Ni distribution on the surface by EDX.

FIGS. 4(a) and (b) show the SEM image of the cross-section of the Ni deposition on MAO treated samples and the Ni distribution of the cross-section by EDX.

FIG. 5 (a) and (b) shows the black coloration of MAO treated samples by sol-gel process. Different silanes were used in the treatment processes. The colors of the two samples are basically the same and match with the standard color code PANTONE 19-0303. FIG. 5(c) shows XRD peaks of MAO sample further treated by sol-gel process before and after annealing. FIG. 5 (d) shows a Raman shift of MAO sample further treated by sol-gel process before and after annealing.

### DETAILED DESCRIPTION OF THE PREFERRED EMBODIMENTS

As used herein and in the claims, “comprising” means including the following elements but not excluding others.

As used herein and in the claims, “couple” or “connect” refers to electrical coupling or connection either directly or indirectly via one or more electrical means unless otherwise stated.

As used herein and in the claims, “MAO treated Mg alloy” refers to Mg alloy comprises a Mg based ceramic layer formed on the surface of the Mg alloy during MAO treatment.

This invention relates to the methods of forming functional coatings on the surface of micro-arc oxidation (MAO) treated Mg alloys and modifying its corrosion resistance by hydrophobic treatment, electrical properties by electro-less Ni deposition, and enhancing color appearance by sol-gel processes

### EXAMPLE 1

### MAO Treatment

Samples made of commercial grade Mg alloy AZ31B were used in the experiments and the chemical compositions thereof were listed in the Table 1. A skilled person in the art would understand that other Mg alloys comprising at least 88% Mg will also be suitable for the instant invention. Samples with size of 30 mm×30 mm×1 mm were treated with Micro-arc oxidation method. First, the electrolyte for MAO treatment is prepared by dissolving 20-30 g/L silicates, 5-30 g/L phosphates, and 3-6 g/L hydroxide into the DI water inside a stainless steel bath. Then a current with a current density of 33-89 A/dm² is applied on Mg alloy samples immersed in the electrolyte bath with a pulse frequency of 500-2600 Hz for time duration of 240-720 seconds. Chemically and mechanically protective Mg based ceramic layer is formed on the surface thereof during the processes. The water contact angle thereof is 91.4°. The surface is electrically insulating.

TABLE 1
Chemical composition of Mg alloy AZ31B

| Elements | Al | Zn | Mn | Mg |
|---|---|---|---|---|
| Weight [%] | 3.17 | 0.78 | 0.31 | Balance |

### EXAMPLE 2

### Hydrophobic Treatment

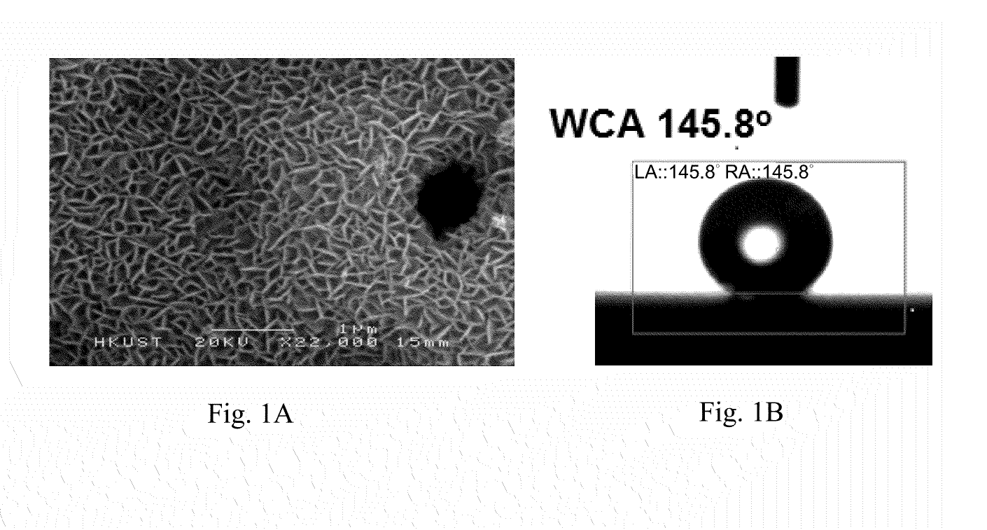

In one embodiment of the invention, a hydrophobic treatment process on the MAO treated Mg alloys (MAO samples) is provided. Chemical etching processes were applied by immersing MAO samples in the 0.125 mol/L NaOH solution at room temperature for 24 hours. Fine nano-structures with length of 100-200 nm, as shown in FIGS. 1(a) and (b), were formed on the MAO treated surfaces. Flank-like structures were formed on the surface of micro-porous MAO treated Mg alloys that would contribute in the achieved enhanced hydrophobic behavior. Then the etched samples were immersed into a solution containing 1 g perfluorodecyltrimethoxysilane (or 0.4 g triethoxyoctylsilane or 1 g perfluorodecyltriethoxysilane) and 10 g ethanol at room temperature for 1 hour to form a very thin silane layer , followed by a drying process at 180 ° C. for 1 hour. The water contact angle thereof was increased to 145.8°.

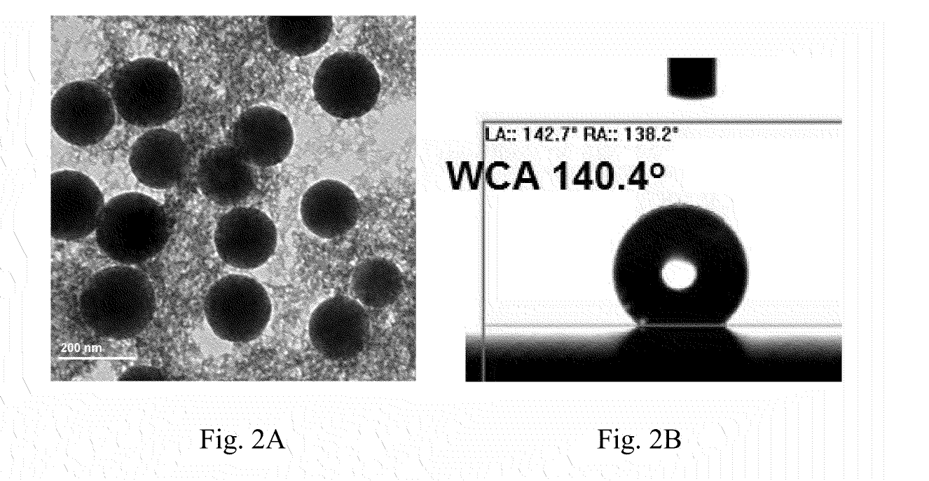

In another embodiment of the invention, a second hydrophobic treatment process is provided. Tetraethyl orthosilicate (TEOS) and C₂H₅OH (5 mL) were added drop-wise and slowly to the mixture of NH₄OH, H₂O and C₂H₅OH (30.5 mL). The mixture was stirred for 75 min at 60° C. to obtain the colloidal silica. The sol solution turned from transparent to white opaque. MTES (1.6 mL) and C₂H₅OH (5 mL) were then added drop-wise to the mixture solution slowly. The solution was stirred for 19 hours at 60° C. and further aged for 3 days under ambient temperature. White opaque solution could be obtained. MAO samples were dipped into the hydrophobic silica sol-gel for 15 min, and withdrawn very slowly and dried at 110° C. for 30 min to remove the residual solvents. The procedure was repeated twice to form an additional film on the MAO treated surface. The film and the water contact angle thereof were shown in FIGS. 2(a) and (b) respectively. The water contact angle thereof was increased to 140.4°.

The corrosion resistance of MAO samples is also enhanced due to the enhanced hydrophobic property. Specifically, for the second hydrophobic treatment as mentioned above, as there is an additional layer of nano-particles on top of the MAO surface, performance from the salt spray test is better than that without the hydrophobic treatment, as illustrated from the result that there is no black dots on the surface treated with the second hydrophobic treatment during salt spray tests.

### EXAMPLE 3

### Electrically Conductive Treatment

The following three-step electro-less Ni deposition procedures are conducted to form electrically conductive coatings onto the MAO treated Mg alloy (MAO samples). The first step is pre-treatment process, where MAO samples are immersed into the 2 g/L ethanol solution of nickel acetate for 20 s at room temperature, and washed by DI water.

The second step is the activation process, where MAO samples are immersed in the 8 g/L ethanol solution of NaBH₄ for 5 min at room temperature, and washed by DI water. NaBH₄ serves as a reducing agent to reduce nickel acetate on the MAO treated surface, such that some reduced nickel particles are formed in the pores of the MAO treated surface; in that sense, NaBH₄ further serve as seeds for the following steps.

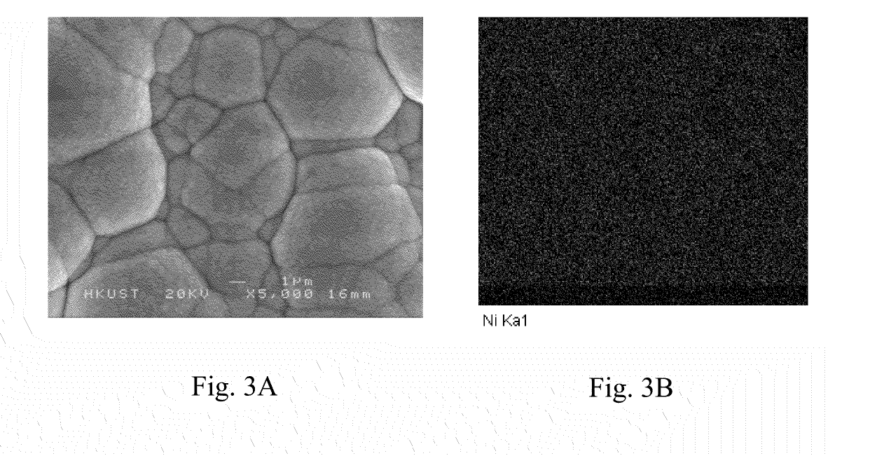

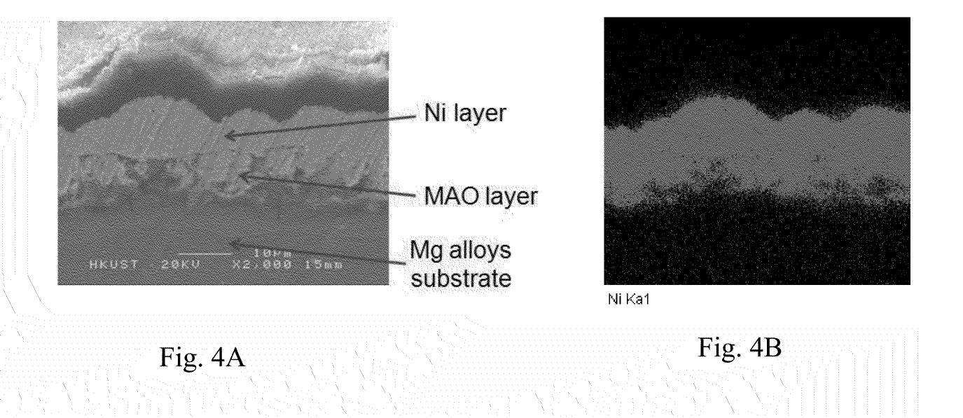

The third step is the electro-less Ni deposition process, where a mixed aqueous solution is formed by NiSO₄.6H₂O: 10-50 g/L, NaH₂PO₂.H₂O: 20-40 g/L, Na-citrate: 20 g/L, H₃BO₃ (Boric acid): 20 g/L, C₃H₆O₃ (Lactic acid): 15 mL/L, Thiourea: 0-2 mg/L. The MAO samples are immersed in the mixed aqueous solution (pH 10-11) for 50 min at 70° C., and washed by DI water. FIGS. 3(a) and (b) show the SEM image of the surface of the Ni deposition on MAO samples and the Ni distribution on the surface by EDX. FIGS. 4(a) and (b) show the SEM image of the cross-section of the Ni deposition on MAO samples and the Ni distribution of the cross-section by EDX. Nickel was deposited with a thickness of 10 μm on top of the MAO treated surface. The sheet resistance thereof is ≧0.05 Ω/sq measured by the four-point-probe method. The results indicate that an electroless Ni with good uniformity and corrosion resistance is deposited on the MAO treated surface.

It is shown that Nickel is uniformly deposited on the MAO treated surface according to the EDX result. This new combination of surfaces can be used on electronic housing materials, especially for those that require both excellent corrosion resistance and electrical conductivity, such as outdoor lighting fixtures and outdoor portable electronics, etc.

### EXAMPLE 4

### Color Treatment

For the color treatment on MAO treated surface, a solution is formed by mixing TEOS (1-10 g) and C₂H₅OH (20-100 mL), NH₄OH (1-10 mL) and H₂O (0-5 mL). The mixture was stirred for 60 min at 60° C. Triethoxy(octyl)silane (OTES) (1-10 mL) was added drop-wise into the mixed solution. The mixture was continuously stirred for 6 hours at 60° C. and then aged for 24 hours at room temperature. MAO samples were dipped into the hydrophobic silica sol for 10 minutes, and dried at 100° C. for 30 minutes to remove the residual solvents. The procedure was repeated for three more times to get enough thickness of the silica film. After dip coating, the samples were annealed at 400° C. for 2 hours under vacuum. Black coloration was then formed on MAO treated surfaces to meet the aesthetic need of the market.

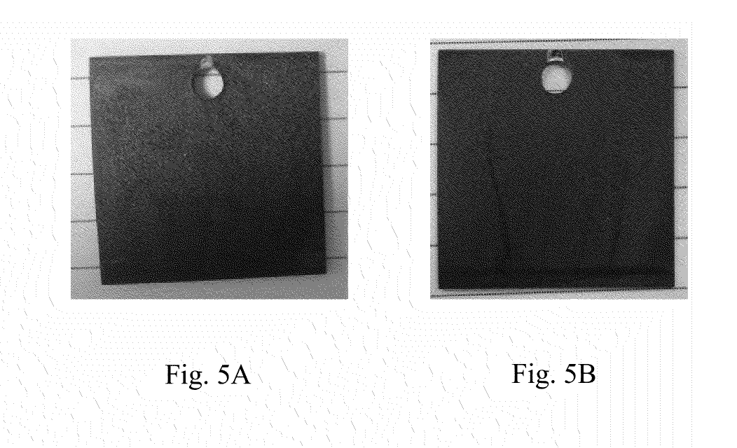

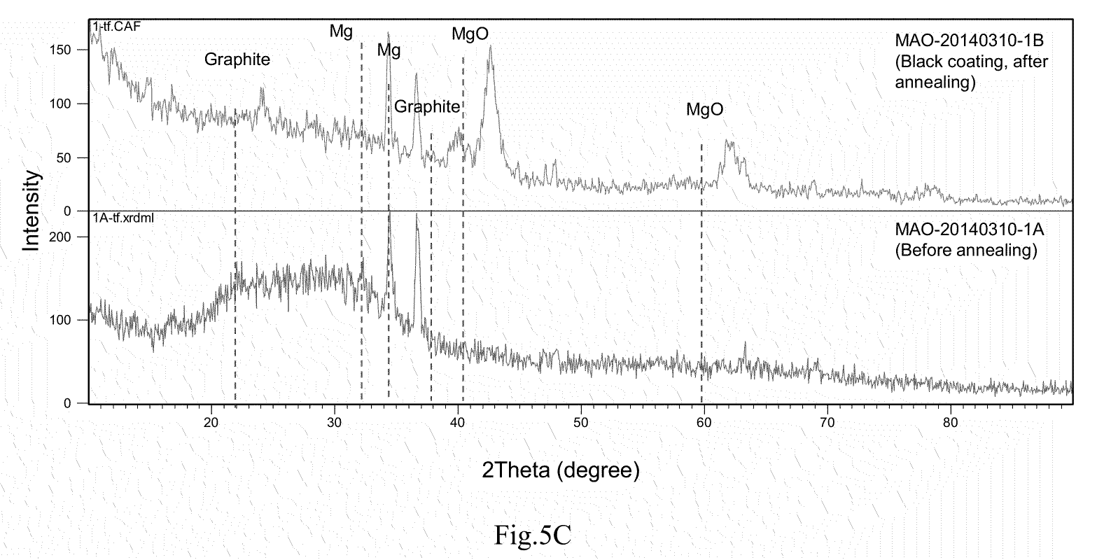

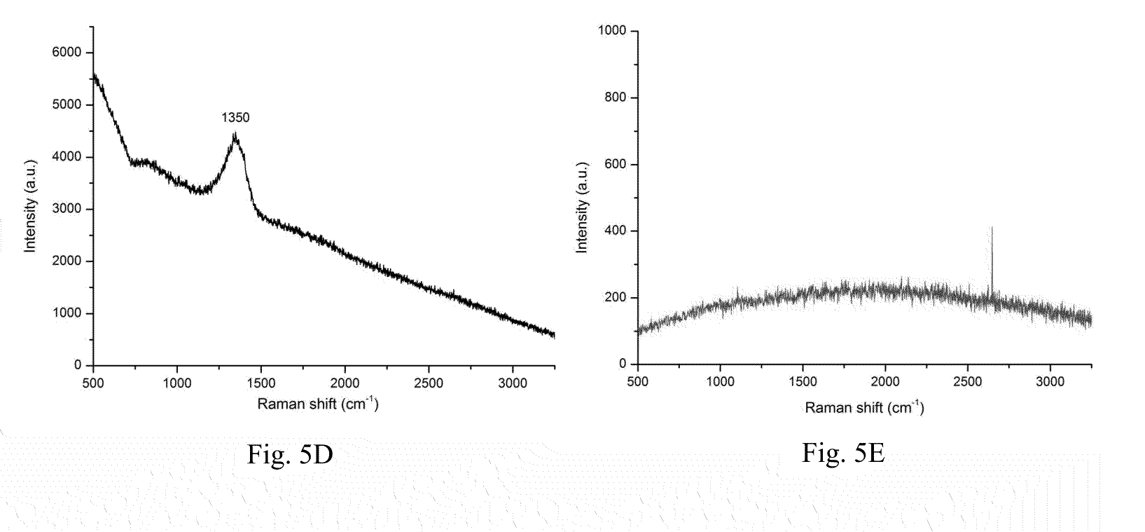

FIGS. 5 (a) and (b) show the uniform black coloration of MAO treated samples by sol-gel process. The colors of the two samples are basically the same and match with the standard color code PANTONE 19-0303. FIG. 5(c) shows the XRD of the treated surface in which the blue curve demonstrates the MAO sample surface before coloration, while the red curve shows the MAO sample surface after coloration. The black color is believed to be the graphite produced during annealing. In FIG. 5(d), a Raman spectrum of the treated surface is shown in which the red curve shows the MAO sample surface before coloration, while the black curve shows the MAO sample surface after coloration. The typical peak of the black curve at 1350 cm⁻¹ shows the existence of graphite after the annealing.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

### REFERENCE:

1. J. E. Gray, B. Luan, “Protective coatings on magnesium and its alloys—a critical review”, Journal of Alloys and Compounds 336 (2002) 88-113.

What is claimed is:

1. A method of treating the surface of micro-arc oxidation treated magnesium alloy, comprising:
a) providing a micro-arc oxidation treated magnesium alloy sample;
b) immersing said sample into a solution; and
c) drying said sample of said step (b);
wherein, the surface of said treated sample obtained from said step (c) is super-hydrophobic.

2. The method of claim 1, wherein the water contact angle of said surface of said treated sample after said step (c) is at least 140.4°.

3. The method of claim 1, wherein said sample of step (a) is etched with NaOH solution before step (b).

4. The method of claim 3, wherein said solution is selected from a group consisting of perfluorodecyltrimethoxysilane, triethoxyoctylsilane and perfluorodecyltriethoxysilane.

5. The method of claim 1, wherein said solution is tetraethyl orthosilicate mixed with silanes, and said step (b) and step (c) are repeated twice.

6. A magnesium alloy comprising
a magnesium based ceramic layer of 5-40 μm thickness; and a super-hydrophobic coating thereon, wherein said coating comprises a silane layer such that said alloy has a water contact angle of at least 140.4°.

7. The magnesium alloy of claim 6 wherein the surface of said alloy comprises a flake-like structure; the flake of said flake-like structure has a length of 100-200 nm.

8. The magnesium alloy of claim 7 manufactured by the method of claim 3 or 4.

9. The magnesium alloy of claim 6, wherein said surface comprises nanoparticles with a size of 200 nm.

10. The magnesium alloy of claim 9 manufactured by the method of claim 5.

11. A method of treating the surface of micro-arc oxidation treated magnesium alloy, comprising
a) providing a micro-arc oxidation treated magnesium alloy sample;
b) pre-treating said sample with nickel acetate solution in ethanol solution;
c) activating said pre-treated sample with a solution of reducing agent; and
d) forming electro-less Ni on the surface of said activated sample with a deposition solution,
wherein, said treated sample obtained from step (d) is electrically conductive.

10. The method of claim 9, wherein said solution of reducing agent is an ethanol solution of NaBH₄.

11. The method of claim 9, wherein said deposition solution comprises NiSO₄.6H₂O, NaH₂PO₂.H₂O, Na-citrate, H₃BO₃, C₃H₆O₃ and thiourea.

12. The method of claim 9, wherein said magnesium alloy has a sheet resistance of said treated sample obtained from step (d) is less than 0.05 Ω/sq.

13. A magnesium alloy comprising a layer of nickel of 10-30 μm thickness on said alloy with a micro-arc oxidation treated layer of 5-40 μm thickness therebetween; said layer of nickel forming a uniform surface on said micro-arc oxidation treated layer to provide improved conductivity such that said alloy has a sheet resistance of less than 0.05 Ω/sq.

14. The magnesium alloy of claim 13 wherein said micro-arc oxidation treated layer has pores with an average pore size of 1-3 μm that are filled by nickel.

15. The magnesium alloy of claim 13 manufactured by the process of claim 9.

16. A method of treating the surface of micro-arc oxidation treated magnesium alloy, comprising:
a) providing a micro-arc oxidation treated magnesium alloy sample;
b) immersing said sample into a silane solution;
c) drying said sample of said step (b); and
d) annealing said sample of said step (c);
wherein said solution is tetraethyl orthosilicate mixed with silanes, and said step (b) and step (c) are repeated three more times;
wherein the color of said surface matches with the standard color code PANTONE 19-0303.

17. A magnesium alloy comprising a magnesium based ceramic layer of 5-40 μm thickness, and a silane coating thereon, wherein surface color of said alloy matches with the standard color code PANTONE 19-0303.

18. The magnesium alloy of claim 17 manufactured by the process of claim 16.
